(19) United States
(12) Patent Application Publication
(10) Pub. No.: US 2021/0357461 A1
(43) Pub. Date: Nov. 18, 2021

(54) METHOD, APPARATUS AND STORAGE MEDIUM FOR SEARCHING BLOCKCHAIN DATA

(71) Applicant: Shanghai Dianrong Information Technology Co., Ltd., Shanghai (CN)

(72) Inventor: Shiyuan Xiao, Shanghai (CN)

(21) Appl. No.: 17/265,573

(22) PCT Filed: Jul. 29, 2019
(86) PCT No.: PCT/CN2019/098135

§ 371 Date: Feb. 3, 2021

(30) Foreign Application Priority Data
Aug. 3, 2018 (CN) 201810876764.5

(51) Int. Cl. G06F 16/953; G06F 16/25; G06F 16/22; G06F 16/27; G06F 16/955

(52) U.S. Cl. CPC G06F 16/953; G06F 16/256; G06F 16/9566; G06F 16/27; G06F 16/2237

(57) ABSTRACT

The disclosure of the present invention provides a method for searching blockchain data, the method comprises: A. receiving a webpage read request sent by a search engine via a hypertext transfer protocol (HTTP) interface, the webpage read request including a first uniform resource locator address; B. obtaining first blockchain data at the first uniform resource locator address; C. determining whether there is at least one second uniform resource locator address, wherein second blockchain data at the at least one second uniform resource locator address is associated with the first blockchain data; D. generating a webpage associated with the first uniform resource locator address according to the first blockchain data and the at least one second uniform resource locator address, in the case where there is the at least one second uniform resource locator address; and E. returning the webpage to the search engine via the HTTP interface.

### FIELD OF THE DISCLOSURE

The disclosure of the present invention relates to blockchain searching technology, and more in particular to a method for searching blockchain data, an apparatus for searching blockchain data executing the above method for searching blockchain data, and a corresponding computer-readable storage medium.

### BACKGROUND

A search engine refers to a system that automatically collects information from the World Wide Web and provides the information sorted to users for inquiries. During collecting information by the search engine, the search engine utilizes a so-called spider program to connect to the hyperlinks of each webpage. According to the hyperlinks to which the webpages are linked, just like the “to spread far and wide . . . ” in daily life, the spider program starts from a few of webpages and connects to all other web links on the Internet. In theory, if there are appropriate hyperlinks on a webpage, the spider program can traverse most webpages.

Blockchain is an intelligent peer-to-peer network that uses distributed databases to identify, propagate, and record information, also known as the value Internet. The so-called value Internet refers to enabling users to transfer value conveniently, quickly, and at low costs by the Internet.

### SUMMARY

Embodiments of the present invention provide a method, apparatus and computer-readable storage medium for searching blockchain data, so that the search engine can collect information from the blockchain network, thereby achieving a search service for the blockchain network.

For this purpose, the first aspect of the embodiments of the present invention provides a method for searching blockchain data, comprising:

A. receiving a webpage read request sent by a search engine via a hypertext transfer protocol (HTTP) interface, the webpage read request including a first uniform resource locator address;

B. obtaining first blockchain data at the first uniform resource locator address;

C. determining whether there is at least one second uniform resource locator address, wherein second blockchain data at the at least one second uniform resource locator address is associated with the first blockchain data;

D. generating a webpage associated with the first uniform resource locator address according to the first blockchain data and the at least one second uniform resource locator address, in the case where there is the at least one second uniform resource locator address; and

E. returning the webpage to the search engine via the HTTP interface.

In addition, the second aspect of the embodiments of the present invention also provides an apparatus for searching blockchain data, the data apparatus includes: a processor; and a memory used to store instructions, when the instructions are executed, the processor performs the following operations:

A. receiving a webpage read request sent by a search engine via a hypertext transfer protocol (HTTP) interface, the webpage read request including a first uniform resource locator address;

B. obtaining first blockchain data at the first uniform resource locator address;

C. determining whether there is at least one second uniform resource locator address, wherein second blockchain data at the at least one second uniform resource locator address is associated with the first blockchain data;

D. generating a webpage associated with the first uniform resource locator address according to the first blockchain data and the at least one second uniform resource locator address, in the case where there is the at least one second uniform resource locator address; and

E. returning the webpage to the search engine via the HTTP interface.

Finally, the third aspect of the embodiments of the present invention provides a computer-readable storage medium having computer-readable program instructions stored thereon, and the computer-readable program instructions are used to execute the method for searching blockchain data according to the first aspect of the embodiment of the present invention.

In the embodiment of the present invention, the blockchain node can process the request sent by the search engine by adding an HTTP interface; secondly, the search engine can obtain, process and store the blockchain data displayed in the form of a webpage by generating the blockchain data as a webpage; thirdly, the search engine can traverse the blockchain data in the form of traversing the webpage by adding the uniform resource locator address to the generated webpage. Therefore, with the embodiment of the present invention, the search engine can retrieve the blockchain data, so that the user of the search engine can search the information existing in the blockchain by the search engine, which achieves the search service for the blockchain network. Other advantages of the present invention will be further explained below.

### BRIEF DESCRIPTION OF THE DRAWINGS

The features, advantages, and other aspects of the present invention will become more apparent from the following detailed description taken in conjunction with the accompanying drawings, several embodiments of the present invention have been illustrated by way of example and not by way of limitation herein.

FIG. 1 illustrates a flowchart of a method 100 for searching blockchain data according to the disclosure of the present invention;

FIG. 2 illustrates a network architecture diagram 200 in which the method 100 illustrated in FIG. 1 can be implemented;

FIG. 3 illustrates a diagram 300 of blockchain data with an attribute A1 stored in a Key/Value manner;

FIG. 4 illustrates a diagram 400 of storing public data and private data in different ledgers;

FIG. 5 illustrates an example of blockchain data 500 with an attribute A2 stored in a Key/Value manner;

FIG. 6 illustrates a diagram of an apparatus 600 for searching blockchain data according to one embodiment of the present invention; and

FIG. 7 illustrates a diagram of an apparatus 700 for searching blockchain data according to another embodiment of the present invention.

### DETAILED DESCRIPTION

Various exemplary embodiments of the present invention are described in detail below with reference to the accompanying drawings. Although the example methods and apparatuses described below include software and/or firmware executed on hardware in other components, it should be noted that these examples are only illustrative and should not be regarded as limited. For example, it can be considered that any or all hardware, software, and firmware components can be implemented exclusively in hardware, exclusively in software, or in any combination of hardware and software. Therefore, although example methods and apparatuses have been described below, those skilled in the art should easily appreciate that the provided examples are not used to limit the ways for implementing these methods and apparatuses.

In addition, the flowcharts and block diagrams in the accompanying drawings illustrate the possible implemented architecture, functions, and operations of the method and system according to various embodiments of the present invention. It should be noted that the functions noted in the blocks may also occur in a different order than the order noted in the drawings. For example, two blocks shown in succession may be executed substantially in parallel, or they may sometimes be executed in the reverse order, depending on the functions involved. It should also be noted that each block in the flowchart and/or block diagrams, and the combination of the blocks in the flowchart and/or block diagrams can be implemented using a dedicated hardware-based system that performs the specified functions or operations, or can be implemented using a combination of dedicated hardware and computer instructions.

The term “read” of “webpage read request” in the disclosure of the present invention includes capturing the webpage by the search engine and obtaining the webpage by the user device, wherein obtaining the webpage by the user device specifically refers to that the user queries or browses the webpage generated by the blockchain data by the user device.

The term “user device” in the disclosure of the present invention refers to smart terminals including but not limited to smart phones, tablet computers, desktop computers, and notebook computers.

The term “uniform resource locator address” in the disclosure of the present invention refers to the address of a standard resource in the Internet, also known as a Uniform Resource Locator (URL) or a webpage address. Correspondingly, the term “first uniform resource locator address” in the disclosure of the present invention refers to the uniform resource locator address of the current level when the method for searching blockchain data according to the present invention is executed, that is, the current level URL; and the term “second uniform resource locator address” in the disclosure of the present invention refers to the uniform resource locator address of the next-level when the method for searching blockchain data is executed according to the present invention, that is, the secondary URL.

The term “first blockchain data” in the disclosure of the present invention refers to the blockchain data at the first uniform resource locator address in the blockchain; correspondingly, the term “Second blockchain data” in the disclosure of the present invention refers to the blockchain data at the second uniform resource locator address in the blockchain.

The term “public data” in the disclosure of the present invention refers to the data that can be accessed without identity verification, and “private data” refers to the data that can be accessed with identity verification.

The term “attribute A1” in the disclosure of the present invention refers to the data format name used to indicate the data parsing method of the blockchain data or the data format analytical function, the data format parsing service, or the data format parsing smart contract address used to indicate the data parsing method of the blockchain data. The term “attribute A2” is used to mark the blockchain data as private or public, wherein when the blockchain data is public data, the “attribute A2” has a first value, and when the blockchain data is private, the “attribute A2” has a second value different from the first value.

The terms “first” and “second” in the disclosure of the present invention are only used to describe the reference, purpose or a specific thing, but cannot be understood as indicating or implying relative importance or implicitly indicating the indicated the number of the technical features.

The term “plurality” in the disclosure of the present invention refers to two or more.

The terms “retrieve” and “search” appear in the disclosure of the present invention, wherein the term “retrieve” refers to the process that the search engine captures, processes, traverses blockchain data, and builds index of the blockchain data by the web spider program, and the term “search” refers to that the search engine finds the web content of webpages where the index has been built previously after receiving the user's input of keywords in the search engine page.

The expression “the second blockchain data at the at least one second uniform resource locator address is associated with the first blockchain data” in the disclosure of the present invention refers to that a hierarchical attribute and a predetermined hierarchical relationship tree included in the first blockchain data indicate whether there is an association relationship of the second blockchain data at the second uniform resource locator address.

The term “hierarchical relationship tree” in the disclosure of the present invention refers to a logical relationship tree which is predetermined and indicates the hierarchical structure of the webpage generated by the accessed blockchain data.

The term “hierarchical attribute” in the disclosure of the present invention refers to information indicating which level of the above-mentioned hierarchical relationship tree the uniform resource locator address associated with the read webpage belongs to.

The term “first attribute” in the disclosure of the present invention is used to mark the blockchain data as private or public, wherein the term “first value” indicates that the blockchain data associated therewith is public data, and the term “second value” indicates that the blockchain data associated therewith is private data.

The term “public ledger” in the disclosure of the present invention refers to a blockchain ledger in which only public data that can be accessed without identify verification is stored.

The term “private ledger” in the disclosure of the present invention refers to a blockchain ledger in which only private data that can be accessed with identify verification is stored.

The term “public area of the ledger” in the disclosure of the present invention refers to the area of the ledger for storing public data.

The term “privacy area of the ledger” in the disclosure of the present invention refers to the area of the ledger for storing private data.

As mentioned above, users of search engines cannot search the data located in the blockchain by current search engines. In order to realize the search service with excellent performance for the blockchain network, the embodiments of the present invention mainly focus on the following problems: firstly, the current blockchain node cannot process the HTTP request sent by the search engine; secondly, the current search engine stores the retrieved webpages in the database, and directly obtains the corresponding webpage information from the database after receiving the user's search request to provide it to the user. However, in the blockchain network, information is stored in a specific data format not in the form of webpage text. Furthermore, current web search engines traverse the information in the network by the way of capturing webpages by the web spider program, but the current search engines cannot traverse the blockchain data in the blockchain network.

In addition, what the current search engine searches should be public data, and the blockchain network may store both public data and private data, these two types of data should be distinguished during searching.

To solve these problems and realize the search service for the blockchain network, the embodiment of the present invention first provides an HTTP interface which is located in a blockchain node, for example, such that the blockchain node can process HTTP requests sent by the search engine. Secondly, the embodiment of the present invention also provides a method for converting data in a specific data format such as XML or JSON into a webpage. Furthermore, the embodiment of the present invention adds the uniform resource locator addresses of other webpages as information into the webpage, so that the search engine can link to other webpages through the webpage, which realizes the webpage capturing function for the blockchain network. In addition, the embodiment of the present invention also executes distinguishing process for public data and private data in the blockchain network. More specific implemented methods and other advantages of the present invention refer to the description below.

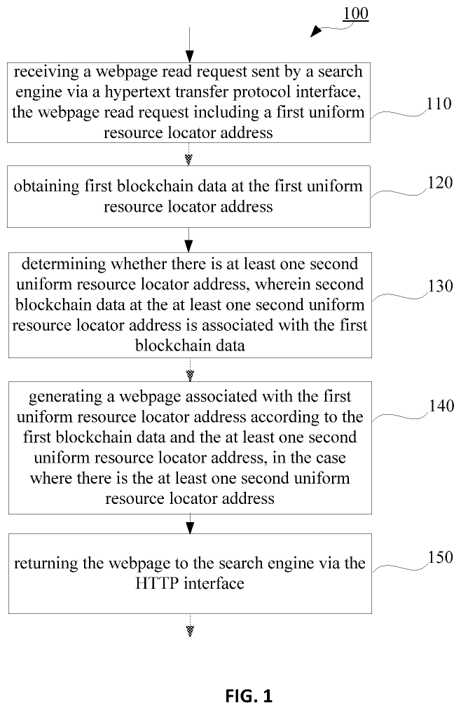

FIG. 1 illustrates a flowchart of the method 100 for searching blockchain data, it can be seen from FIG. 1 that the method 100 at least comprises the following five steps, that is, firstly, in the step 110 of the method, receiving a webpage read request sent by a search engine via a HTTP interface, the webpage read request including a first uniform resource locator address; secondly, in the step 120 of the method, obtaining first blockchain data at the first uniform resource locator address; next, in the step 130 of the method, determining whether there is at least one second uniform resource locator address, wherein second blockchain data at the at least one second uniform resource locator address is associated with the first blockchain data; and then, in the step 140 of the method, generating a webpage associated with the first uniform resource locator address according to the first blockchain data and the at least one second uniform resource locator address, in the case where there is the at least one second uniform resource locator address; at last, in the step 150 of the method, returning the webpage to the search engine via the HTTP interface.

The above-mentioned method 100 for searching blockchain data can further comprise the following step, that is, generating the webpage according to the first blockchain data in the case where there is no the at least one second uniform resource locator address.

On one hand, by the way of providing the HTTP interface, on the other hand, by the way of generating a webpage associated with the data of the blockchain data according to the blockchain data, the search engine can traverse the webpage associated with the blockchain data, such that the search engine can search the blockchain data after the user of the search engine inputting the search keywords.

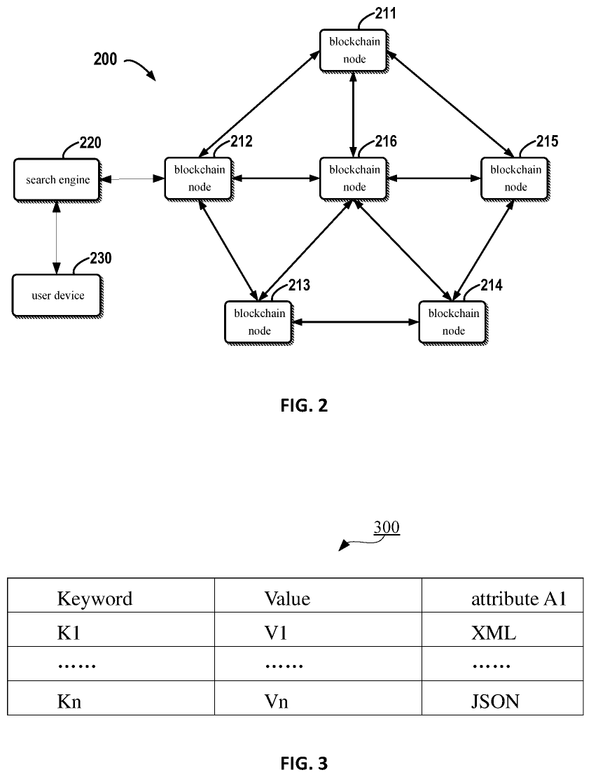

A network architecture diagram, in which the method according to the present invention is implemented, can be described below together with FIG. 2. FIG. 2 illustrates a network architecture diagram 200 in which the method 100 shown in FIG. 1 can be implemented. It can be seen from the figure that the architecture 200 includes blockchain nodes 211, 212, 213, 214, 215, and 216. These blockchain nodes can synchronize data through the network, but the current blockchain network does not support search engines to retrieve its data.

As mentioned above, an HTTP interface is provided on a blockchain node such as the blockchain node 212, and then the search engine 220 can access the blockchain network through the HTTP interface. After retrieving the data of the blockchain network, when the search engine 220 receives a search request from the user of the search engine through the client 230, it can search the results obtained from the previous retrieval to achieve the search of the blockchain data.

Specific to how to generate a webpage associated with the data in the blockchain data, there can be various implementations. For example, a webpage can be generated according to the first uniform resource locator address, that is, the blockchain data pointing to the first URL, further, in the case that there is at least one second uniform resource locator address, that is, the second uniform resource locator address URL, the second uniform resource locator address URL can also be presented on the webpage, therefore, the webpage can include both blockchain data and the uniform resource locator address URL. In the case of having multiple uniform resource locator addresses URLs, these uniform resource locator addresses URLs can be sequentially arranged in the webpage. It can also be achieved by the way of generating a logical search tree diagram associated with the data in the blockchain data according to the logical relationship of the blockchain data.

When specifically capturing webpage information, the search engine can add the following function, that is, the search engine can access the entry address of the blockchain (for example: http://test.com.homepage), so that the search engine can access the blockchain. After receiving a webpage read request at the blockchain side, firstly obtaining the first blockchain data at a uniform resource locator address URL included in the webpage read request according to the uniform resource locator address URL, and then determining whether there are other uniform resource locator addresses URLs, and how to determine specifically, it will be determined whether there is at least one second uniform resource according to the hierarchical attributes and the predetermined hierarchical relationship tree included in the first blockchain data. If the predetermined hierarchical relationship tree indicates that there is at least one second uniform resource locator address, the second uniform resource locator address will also be placed in the above-mentioned generated webpage.

Next, returning the webpage to the search engine. After the search engine receives the returned webpage, it can directly extract the blockchain data and its access address, and can also initiate further webpage read requests to the blockchain network side to capture subsequent blockchain data.

Specifically, when the above webpage is generated, the hierarchical attribute included in the blockchain data can also play a very important role, determining whether there is at least one second uniform resource locator address URL will be according the hierarchical attributes and the predetermined hierarchical relationship tree included in the first blockchain data. Specifically, for example, the hierarchical attribute of blockchain data A is “finance”, and the predetermined hierarchical relationship tree indicates that there is blockchain data B with the hierarchical attribute of “finance/blockchain finance”, then blockchain data B is the next level blockchain data of blockchain data A. If the webpage read request is to capture the blockchain data A with the hierarchical attribute of “finance”, then the uniform resource locator address URL of the blockchain data B pointing to the hierarchical attribute of “finance/blockchain finance” will also be generated in the webpage, that is, the generated webpage includes the uniform resource locator address URL of the blockchain data B pointing to the hierarchical attribute of “finance/blockchain finance”.

For another example, if the hierarchical attribute of blockchain data C is “China”, and the predetermined hierarchical relationship tree indicates that there is another blockchain data D whose hierarchical attribute is “China/Shanghai”, then blockchain data D is the next level blockchain data of blockchain data C. If the webpage read request is to capture the blockchain data C with the hierarchical attribute of “China”, then the uniform resource location URL of the blockchain data D pointing to the hierarchical attribute of “China/Shanghai” is also generated in the webpage, that is, the generated webpage includes the uniform resource locator address URL of the blockchain data D pointing to the hierarchical attribute of “China/Shanghai”.

There is also a possibility that there is no other uniform resource locator address URL, so that the webpage can be generated only according to the blockchain data pointed by the uniform resource locator address URL included in the webpage read request.

In addition, to achieve the correct parsing of the blockchain data associated with a link address through the link address, the inventor of the present invention proposes to configure an attribute A1 for the blockchain data, and the attribute A1 is used to specify the parsing way of the blockchain data. For example, the attribute A1 includes a data format name used to indicate the data parsing method of the blockchain data. Those skilled in the art should understand that the attribute A1 can also include the data format analytical function name, data format parsing service address, or data format parsing smart contract address for indicating the data parsing way of the public data and the private data.

At this time, when the search engine accesses the entry address, the attribute A1 in the K/V/A1 of each data indicates the specific data format of the data (for example, XML, JSON, etc.); when the search engine accesses the entry address, the searchable data list can be displayed on the blockchain, when the search engine searches any K value, the blockchain calls the corresponding parsing method according to the value of the corresponding attribute A1 to parse the data to generate the corresponding webpage.

In addition, each blockchain node can implement an HTTP server, for example, the HTTP server pointing to the domain name http://test.com.homepage. This page can display a part of the K/V content, which normally cannot be displayed all at once, because it will be too large to display the all page at once, and at the same time, the search engine can search other K/V data by the way of the next page or even the 10^{th} page and other links (http://test. com.homepage?page=10). At the same time, the content of a single K/V is displayed in the form of link http://test.com.homepage?key=apple, with respective to how to present, it can be defined by different page templates. In addition to using the specific data format name to indicate the data format, the above attribute A1 can also be a format analytical function name or a format parsing service address. It can also be represented by a content code such as 1, 2, and 3, which is more concise and can save storage space.

FIG. 3 illustrates a diagram 300 of blockchain data with an attribute A1 stored in a Key/Value manner, it can be seen from FIG. 3 that the blockchain data such as K1, Kn includes the attribute A1 which includes a data format name for indicating the data parsing method of blockchain data such as K1, Kn. Alternatively, the blockchain data such as K1 and the blockchain data such as Kn can also include the data format analytical function name, the data format parsing service address, or the data format parsing smart contract for indicating the data parsing method of the blockchain data. It can be seen from FIG. 3 that the blockchain data such as K1 has the value of the attribute A1 of “XML”, which indicates that the parsing way of the value is an XML parsing method, correspondingly, the blockchain data such as Kn has the value of the attribute A1 of “JSON”, which indicates that the parsing way of the value is a JSON parsing method. That is, the method of calling the corresponding analytical function or parsing method can parse the blockchain data such as K1, Kn, etc.

When the above link address is achieved, the search engine is also necessary to follow the Robots protocol. Specifically, Robots protocol is also called spider protocol, robot protocol, etc., whose full name is “Robots Exclusion Protocol”, the website tells the search engines which pages can be captured and which pages cannot be captured through Robots protocol.

Specific to the disclosure of the present invention, for each link address in the portal webpage, it is also necessary to inform the search engine which link addresses can be traversed and which link addresses cannot be traversed through the Robots protocol. However, the Robots protocol only informs the search engine which link addresses should be traversed and which link addresses should not be traversed to realize the retrieval of blockchain data, but cannot guarantee that the search engine will comply with the Robots protocol well, therefore, the inventor of the disclosure of the present invention creatively contemplates that the control of the search action of the search engine is implemented using the properties of blockchain data itself, for example, the disclosed blockchain data according to the present invention includes public data and private data, wherein the public data is the data that can be accessed without identity verification and the private data is the data that can be accessed with identity verification, and wherein the public data and the private data are stored in different locations of the blockchain or the public data and the private data have different tags.

The reason for setting this attribute A2 is that in the current mainstream blockchain platforms, public blockchains do not set restrictions on access to blockchain data at all, while consortium blockchains such as Fabric and Corda set restrictions on all blockchain data of the data. It can be seen that the blockchain platform makes the same control of different data but does not have the capacity of making different controls of different accesses. Generally speaking, the enterprise-level blockchains usually use consortium blockchain platforms to make access authority controls of all data, so that the information that needs to be disclosed cannot be retrieved by external search engines. For example, in an insurance sales system implemented using the blockchain, the insurance price, terms and other information in the blockchain are desirable to be searched by search engines without authorization; but other information, such as user information, transaction information, claim records and other information are desirable to be searched by search engines with authorization, otherwise it is not conducive to protecting customer privacy or protecting the business secrets of insurance companies.

Specifically, the implementations and methods that store public data and private data in different locations of the blockchain, or give public data and private data different tags.

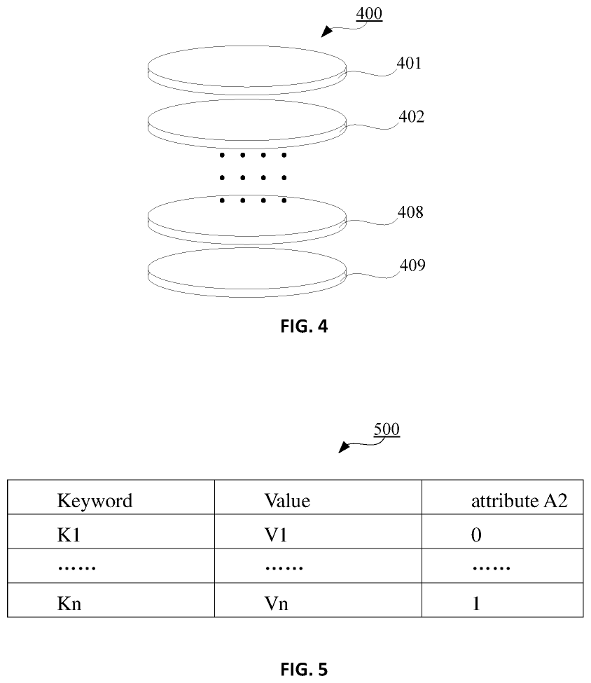

For example, FIG. 4 illustrates a diagram 400 of storing public data and private data in different ledgers, it can be seen from the figure that the blockchain network includes multiple ledgers, such as ledgers 401, 402, . . . , 408, 409, those skilled in the art should understand that the nine ledgers shown here are merely exemplary and not restrictive, of course, those skilled in the art can realize more or fewer ledgers, but the number of ledgers is not the key to the disclosure of the present invention, the key is to distinguish multiple ledgers, for example, the first ledger 401 is marked as a public ledger in which only the above-mentioned public data is stored, such as the above insurance price, terms and other information in the blockchain; and the other ledgers, namely ledgers 402, . . . , 408, 409, are marked as private ledgers in which only private data is stored, such as the above mentioned user information, transaction information, claim records and other information. Those skilled in the art should understand that the number of public ledgers and private ledgers can be dynamically configured according to the required ratio of data to be disclosed and private data of the blockchain. In this way, it is possible to realize the differentiated treatment of data of the blockchain network, thereby providing guarantee for subsequent search services for data of the blockchain.

Alternatively, for example, the first ledger 401 can also be divided into two different areas, and public data is stored in the first area, and private data is stored in the second area, such that the differentiated treatment of data on the blockchain network is implemented to provide guarantee for subsequent search services for data of the blockchain.

By the above way, that is, marking the public data and the private data is implemented by storing the public data and the private data in different ledgers or storing the public data and the private data in different areas of the same ledger, so that the subsequent search stage can distinguish between the public data and the private data based on the type of the ledger or the type of the area of the ledger to provide support for subsequent searches.

Additionally or alternatively, the public data and the private data are stored in different locations of the blockchain or the public data and the private data having different tags can also be implemented by other ways, such as by the way of additional attribute domains, specifically, the public data and the private data may include an attribute A2, wherein the public data has an attribute A2 of such as 0, and the private data has an attribute A2 of such as 1.

For example, each blockchain data can include an attribute A2, when the attribute A2 is 0, it indicates that the blockchain data is public data, and when the attribute A2 is 1, it indicates that the blockchain data is private data. Compared with the above-mentioned technical solution that uses different ledgers or different areas of the same ledger to store public data and private data, adopting public dynamic adjustments allows the technical solution having the additional Attribute A2 indicating that the blockchain is the public data or the private data to allow the administrator to dynamically adjust in real time during the operation of the blockchain, thereby improving the dynamic maintainability of data.

FIG. 5 illustrates an example of data 500 stored in a Key/Value manner. It can be seen from FIG. 5 that the value of the first blockchain data K1 is V1, and its attribute A2 is 0, which indicates that the first blockchain data K1 is public data, and the external search engine can access the public data without any access control or verification; and the value of the n^{th} blockchain data Kn is Vn, and its attribute A2 is 1, which indicates that the blockchain data Kn is private data, and the external search engine can access the private data with access control or verification. That is, the public data K1 and the private data Kn are stored in the Key/Value manner, and the public data has an attribute A2 of 0, and the private data has an attribute A2 of 1. Those skilled in the art should understand that the value of attribute A2 set to 0 or 1 here is merely exemplary and not restrictive, and other technical solutions that can realize the inventive concept disclosed in the disclosure of the present invention which do not deviate from the spirit of the disclosure of the present invention are also included in the protection scope of the appended claims of the disclosure of the present invention.

In view of the technical problem that access to blockchain data of the blockchain network cannot guarantee to meet the search requirements of search engines such as the Robots protocol, the inventor of the present invention has innovatively realized that the attributes of the data of the blockchain network can be transformed to adapt to the search engine, so as to achieve the purpose of searching the data of the blockchain network based on the search engine, in addition, while the retrieval is implemented, it can also satisfy the privacy protection of some data required to be performed privacy protection.

The above method for searching blockchain data can remove the access control for the publicly shared data and reserve the access control for the data required to be performed privacy protection; on the other hand, it defines an internal mechanism and an interface for access and retrieval, which not only can allow the external webpage link to link the public data in the blockchain directly, but also can allow the public data in the blockchain to be linked to each other, so that the search engine can traverse and retrieve all the information in the blockchain. Further, the solution provided by the disclosure of the present invention can implement the interconnection and intercommunication between the blockchain and the Internet information, and further exert the great value of blockchain.

In addition, alternatively, the above method can be implemented by a computer program product, that is, a computer-readable storage medium. The computer program product may include a computer-readable storage medium loaded with computer-readable program instructions for executing various aspects of the present invention. The computer-readable storage medium may be a tangible device that can retain and store instructions used by the instruction execution device. The computer-readable storage medium may be, for example, but not limited to, an electrical storage device, a magnetic storage device, an optical storage device, an electromagnetic storage device, a semiconductor storage device, or any suitable combination of the foregoing. More specific examples (non-exhaustive list) of the computer readable storage media include: a portable computer disk, a hard disk, a random access memory (RAM), a read only memory (ROM), an erasable programmable read only memory (EPROM or flash memory), a static random access memory (SRAM), a portable compact disk read-only memory (CD-ROM), a digital versatile disk (DVD), a memory stick, a floppy disk, a mechanical encoding device, such as a punch card or a convex structure in a groove in which instructions are stored, and any suitable combination of the foregoing. The computer-readable storage medium used here is not interpreted as a transient signal itself, such as radio waves or other freely propagating electromagnetic waves, electromagnetic waves propagating through waveguides or other transmission media (for example, light pulses through fiber optic cables), or electrical signal transmitted through wires.

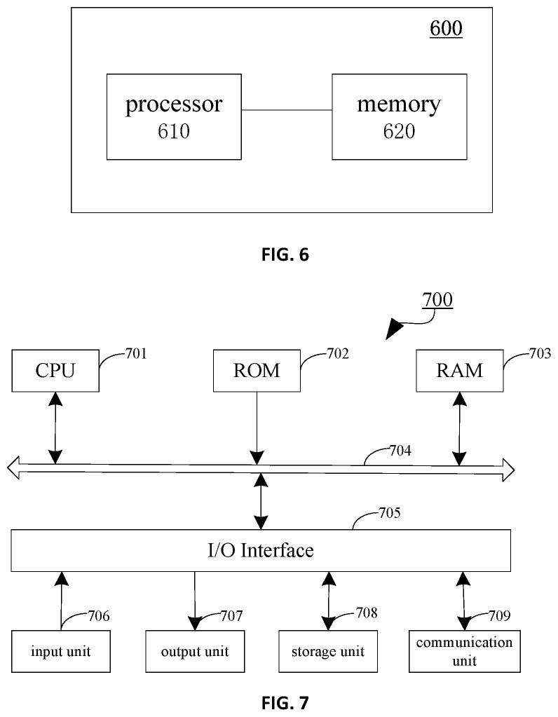

FIG. 6 illustrates a block diagram of an apparatus 600 for searching blockchain data according to an embodiment of the present invention. It can be seen from FIG. 6 that the apparatus 600 for searching blockchain data comprises a processor 610 and a memory 620 coupled to the processor 610.

The memory 620 stores instructions. When the instructions are executed by the processor 610, the processor 610 performs the following actions:

A. receiving a webpage read request sent by a search engine via a hypertext transfer protocol (HTTP) interface, the webpage read request including a first uniform resource locator address

B. obtaining first blockchain data at the first uniform resource locator address;

C. determining whether there is at least one second uniform resource locator address, wherein second blockchain data at the at least one second uniform resource locator address is associated with the first blockchain data;

D. generating a webpage associated with the first uniform resource locator address according to the first blockchain data and the at least one second uniform resource locator address, in the case where there is the at least one second uniform resource locator address; and

E. returning the webpage to the search engine via the HTTP interface.

In an embodiment of the present invention, when the instruction is executed, the processor 610 further performs the following operations:

D1. generating the webpage according to the first blockchain data in the case where there is no the at least one second uniform resource locator address.

In an embodiment of the present invention, C. determining whether there is at least one second uniform resource locator address further comprises:

C1. determining whether there is the at least one second uniform resource locator address according to a hierarchical attribute and a predetermined hierarchical relationship tree included in the first blockchain data.

In an embodiment of the present invention, B. obtaining first blockchain data at the first uniform resource locator address further comprises:

B1. parsing the first blockchain data at the first uniform resource locator address according to a data format name of the first blockchain data.

In an embodiment of the present invention, B. obtaining first blockchain data at the first uniform resource locator address further comprises:

B2. parsing the first blockchain data at the first uniform resource locator address according to a data format analytical function name, a data format parsing service address, or a data format parsing smart contract address of the first blockchain data.

In an embodiment of the present invention, the first blockchain data and/or the second blockchain data comprises a first attribute, and wherein B. obtaining first blockchain data at the first uniform resource locator address further comprises:

B3. determining whether to obtain the first blockchain data at the first uniform resource locator address according to the first attribute of the first blockchain data.

In an embodiment of the present invention, the first blockchain data and/or the second blockchain data are stored in a Key/Value manner.

In an embodiment of the present invention, the first attribute of the first blockchain data is a first value in the case where the first blockchain data is public data; the first attribute of the second blockchain data is the first value in the case where the second blockchain data is public data; the first attribute of the first blockchain data is a second value different from the first value in a case where the first blockchain data is private data; the first attribute of the second blockchain data is the second value in the case where the second blockchain data is private data.

In an embodiment of the present invention, B. obtaining first blockchain data at the first uniform resource locator address further comprises:

B4. determining whether to obtain the first blockchain data at the first uniform resource locator address according to the storage location of a ledger of the first blockchain data,

wherein the first blockchain data or the second blockchain data is stored in a public ledger in the case where the first blockchain data or the second blockchain data is public data; and the first blockchain data or the second blockchain data is stored in a privacy ledger in the case where the first blockchain data or the second blockchain data is private data.

In an embodiment of the present invention, B. obtaining first blockchain data at the first uniform resource locator address further comprises:

B5. determining whether to obtain the first blockchain data at the first uniform resource locator address according to the storage area location of the first blockchain data,

wherein the first blockchain data or the second blockchain data is stored in a public area of the ledger in the case where the first blockchain data or the second blockchain data is public data; and the first blockchain data or the second blockchain data is stored in a privacy area of the ledger in the case where the first blockchain data or the second blockchain data is private data.

By the above way, that is, marking public data and private data is implemented by storing the public data and the private data in different ledgers or in different areas of the ledger, so that the subsequent search stage can distinguish between the public data and the private data based on the type of the ledger or the type of the area of the ledger to provide support for subsequent searches.

FIG. 7 illustrates a schematic block diagram of an apparatus 700 for searching blockchain data. It should be appreciated that the apparatus 700 may be implemented to implement the functions of the method 100 for searching blockchain data in FIG. 1. It can be seen from FIG. 7 that the apparatus 700 for searching blockchain data comprises a central processing unit (CPU) 701 (for example, a processor), which can perform various appropriate actions and processes according to the computer program instructions stored in a read-only memory (ROM) 702 or the computer program instructions loaded from the storage unit 708 to a random access memory (RAM) 703. In the RAM 703, various programs and data required for the operation of the apparatus 700 can also be stored. The CPU 701, the ROM 702, and the RAM 703 are connected to each other via a bus 704. An input/output (I/O) interface 705 is also connected to the bus 704.

A number of components in the apparatus 700 are connected to the I/O interface 705, including: an input unit 706, such as a keyboard, a mouse, etc.; an output unit 707, such as various types of displays, speakers, etc.; and a storage unit 708, such as a disk, an optical disk, etc.; and a communication unit 709, such as a network card, a modem, a wireless communication transceiver, etc. The communication unit 709 allows the apparatus 700 to exchange information/data with other apparatuses through a computer network such as the Internet and/or various telecommunication networks.

The various methods described above, for example, a method for searching blockchain data can be executed by the processing unit 701. For example, in some embodiments, the method 100 for searching blockchain data may be implemented as a computer software program, which is tangibly included in a machine-readable medium, such as the storage unit 708. In some embodiments, part or all of the computer program may be loaded and/or installed on the apparatus 700 via the ROM 702 and/or the communication unit 709. When the computer program is loaded into the RAM 703 and executed by the CPU 701, one or more actions or steps of the method 100 described above can be executed.

Generally speaking, the various example embodiments of the present invention may be implemented in hardware or special purpose circuits, software, firmware, logic, or any combination thereof. Some aspects may be implemented in hardware, while other aspects may be implemented in firmware or software that may be executed by a controller, microprocessor, or other computing device. When various aspects of the embodiments of the present invention are illustrated or described as block diagrams, flowcharts, or using some other graphical representation, it will be appreciated that the blocks, apparatuses, systems, techniques, or methods described herein can be regarded as non-limited examples are implemented in hardware, software, firmware, dedicated circuits or logic, general-purpose hardware or controllers or other computing devices, or some combination thereof.

Although it is described above that the various example embodiments of the present invention can be implemented in hardware or a dedicated circuit, the above-mentioned data processing device for data processing of blockchain can be implemented in the form of hardware or software, which can be achieved in the form of software, because: in the 1990s, a technological improvement can easily belong to the improvement of the hardware (for example, the improvement of the circuit structure of diodes, transistors, switches, etc.) or the improvement of software (for example, the improvement of method flow). However, with the continuous development of technology, the improvement of many method processes nowadays can almost be implemented by programming the improved method process into the hardware circuit, in other words, the corresponding hardware circuit structure can be obtained by programming different programs of the hardware circuit, the change of the hardware circuit structure is implemented, that is, the improvement of such a method flow can also be regarded as a direct improvement of the hardware circuit structure. Therefore, it cannot be considered that the improvement of a method flow cannot be implemented by hardware entity modules. For example, a programmable logic device (PLD) (such as a Field Programmable Gate Array (FPGA)) is an integrated circuit whose logic function is determined by the user's programming of the device. It is programmed by the designer to “integrate” a digital system on a programmable logic device without requiring the chip manufacturer to design and manufacture a dedicated integrated circuit chip. Moreover, instead of manually making integrated circuit chips, this kind of programming is mostly implemented using “logic compiler” software, which is similar to the software compiler used in program development and writing, but the original code must also be written in a specific programming language before compiling, which is called Hardware Description Language (HDL), and HDL is not only one language, but there are many languages, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc., currently the most commonly used is VHDL (Very-High-Speed Integrated Circuit Hardware Description Language) and Verilog. It should also be clear to those skilled in the art that the method flow needs to be logic programmed using the above-mentioned hardware description languages into an integrated circuit, which can easily obtain the hardware circuit that implements the logic method flow.

The computer readable program instructions or computer program products used to execute various aspects of the disclosure of the present invention can also be stored in the cloud. When needed, the user can access the computer-readable program instructions used to execute one aspect of the disclosure of the present invention through the mobile Internet, the fixed network or other networks, so as to implement the technical solutions disclosed in each aspect of the disclosure of the present invention.

In summary, the method for searching blockchain data proposed in the disclosure of the present invention on one hand can accurately control the data of the blockchain to remove the access control for the publicly shared data and reserve the access control for the data required to be performed privacy protection; on the other hand, to define an internal mechanism and an interface for access and retrieval, which not only can allow the external webpage link to link the public data of the blockchain directly, but also can allow the public data of the blockchain to be linked to each other, so that the search engine can traverse and retrieve all the information in the blockchain. Further, the solution provided by the disclosure of the present invention can implement the interconnection and intercommunication between the blockchain and the Internet information, and further exert the great value of blockchain.

The foregoing descriptions are only alternative embodiments of the disclosure of the present invention, and are not used to limit the embodiments of the present invention, for those skilled in the art, the embodiments of the present invention may have various modifications and changes. Any modification, equivalent replacement, improvement, etc., made within the spirit and principle of the embodiment of the present invention should be included in the protection scope of the embodiment of the present invention.

Although the embodiments of the present invention have been described with reference to several specific embodiments, it should be understood that the embodiments of the present invention are not limited to the disclosed specific embodiments. The embodiments of the present invention are intended to cover various modifications and equivalent arrangements within the spirit and scope of the appended claims. The scope of the claims accords with the broadest interpretation, so as to include all such modifications and equivalent structures and functions.

1. A method for searching blockchain data, comprising:
A. receiving a webpage read request sent by a search engine via a hypertext transfer protocol (HTTP) interface, the webpage read request including a first uniform resource locator address;
B. obtaining first blockchain data at the first uniform resource locator address;
C. determining whether there is at least one second uniform resource locator address, wherein second blockchain data at the at least one second uniform resource locator address is associated with the first blockchain data;
D. generating a webpage associated with the first uniform resource locator address according to the first blockchain data and the at least one second uniform resource locator address, in the case where there is the at least one second uniform resource locator address; and
E. returning the webpage to the search engine via the HTTP interface.

2. The method of claim 1, further comprising:
D1. generating the webpage according to the first blockchain data in the case where there is no the at least one second uniform resource locator address.

3. The method of claim 1, wherein C. determining whether there is at least one second uniform resource locator address further comprises:
C1. determining whether there is the at least one second uniform resource locator address according to a hierarchical attribute and a predetermined hierarchical relationship tree included in the first blockchain data.

4. The method of claim 1, wherein B. obtaining first blockchain data at the first uniform resource locator address further comprises:
B1. parsing the first blockchain data at the first uniform resource locator address according to a data format name of the first blockchain data.

5. The method of claim 1, wherein B. obtaining first blockchain data at the first uniform resource locator address further comprises:
B2. parsing the first blockchain data at the first uniform resource locator address according to a data format analytical function name, a data format parsing service address, or a data format parsing smart contract address of the first blockchain data.

6. The method of claim 1, wherein the first blockchain data and/or the second blockchain data comprises a first attribute, and wherein B. obtaining first blockchain data at the first uniform resource locator address further comprises:
B3. determining whether to obtain the first blockchain data at the first uniform resource locator address according to the first attribute of the first blockchain data.

7. The method of claim 6, wherein the first blockchain data and/or the second blockchain data are stored in a Key/Value manner.

8. The method of claim 6, wherein,
the first attribute of the first blockchain data is a first value in the case where the first blockchain data is public data;
the first attribute of the second blockchain data is the first value in the case where the second blockchain data is public data;
the first attribute of the first blockchain data is a second value different from the first value in a case where the first blockchain data is private data;
the first attribute of the second blockchain data is the second value in the case where the second blockchain data is private data.

9. The method of claim 1, wherein B. obtaining first blockchain data at the first uniform resource locator address further comprises:
B4. determining whether to obtain the first blockchain data at the first uniform resource locator address according to the storage location of a ledger of the first blockchain data,
wherein the first blockchain data or the second blockchain data is stored in a public ledger in the case where the first blockchain data or the second blockchain data is public data; and the first blockchain data or the second blockchain data is stored in a privacy ledger in the case where the first blockchain data or the second blockchain data is private data.

10. (canceled)

11. An apparatus for searching blockchain data, the apparatus comprising:
a processor; and
a memory used to store instructions, and when the instructions are executed, the processor can perform the following operations:
A. receiving a webpage read request sent by a search engine via a hypertext transfer protocol (HTTP) interface, the webpage read request including a first uniform resource locator address;
B. obtaining first blockchain data at the first uniform resource locator address;
C. determining whether there is at least one second uniform resource locator address, wherein second blockchain data at the at least one second uniform resource locator address is associated with the first blockchain data;
D. generating a webpage associated with the first uniform resource locator address according to the first blockchain data and the at least one second uniform resource locator address, in the case where there is the at least one second uniform resource locator address; and
E. returning the webpage to the search engine via the HTTP interface.

12. The apparatus of claim 11, when the instructions are executed, the processor can perform the following operations:
D1. generating the webpage according to the first blockchain data in the case where there is no the at least one second uniform resource locator address.

13. The apparatus of claim 11, wherein determining whether there is at least one second uniform resource locator address further comprises:
C1. determining whether there is the at least one second uniform resource locator address according to a hierarchical attribute and a predetermined hierarchical relationship tree included in the first blockchain data.

14. The apparatus of claim 11, wherein B. obtaining first blockchain data at the first uniform resource locator address further comprises:
B1. parsing the first blockchain data at the first uniform resource locator address according to a data format name of the first blockchain data.

15. The apparatus of claim 11, wherein B. obtaining first blockchain data at the first uniform resource locator address further comprises:
B2. parsing the first blockchain data at the first uniform resource locator address according to a data format analytical function name, a data format parsing service address, or a data format parsing smart contract address of the first blockchain data.

16. The apparatus of claim 11, wherein the first blockchain data and/or the second blockchain data comprises a first attribute, and wherein B. obtaining first blockchain data at the first uniform resource locator address further comprises:
B3. determining whether to obtain the first blockchain data at the first uniform resource locator address according to the first attribute of the first blockchain data.

17. The apparatus of claim 16, wherein the first blockchain data and/or the second blockchain data are stored in a Key/Value manner.

18. The apparatus of claim 16, wherein,
the first attribute of the first blockchain data is a first value in the case where the first blockchain data is public data;
the first attribute of the second blockchain data is the first value in the case where the second blockchain data is public data;
the first attribute of the first blockchain data is a second value different from the first value in a case where the first blockchain data is private data;
the first attribute of the second blockchain data is the second value in the case where the second blockchain data is private data.

19. The apparatus of claim 11, wherein B. obtaining first blockchain data at the first uniform resource locator address further comprises:
B4. determining whether to obtain the first blockchain data at the first uniform resource locator address according to the storage location of a ledger of the first blockchain data,
wherein the first blockchain data or the second blockchain data is stored in a public ledger in the case where the first blockchain data or the second blockchain data is public data; and the first blockchain data or the second blockchain data is stored in a privacy ledger in the case where the first blockchain data or the second blockchain data is private data.

20. (canceled)

21. A computer-readable storage medium having computer-readable program instructions stored thereon, the computer-readable program instructions are used to execute the method for searching blockchain data according to claim 1.
